(19) United States
(12) Patent Application Publication
(10) Pub. No.: US 2009/0321524 A1
(43) Pub. Date: Dec. 31, 2009

(54) Method and System for Adapting a Mobile Computing Device with a Face Module Expansion Port

(76) Inventors: David Bellows, Wantagh, NY (US); Thomas Wulff, North Patchogue, NY (US)

Correspondence Address: FAY KAPLUN & MARCIN, LLP, 150 BROADWAY, SUITE 702, NEW YORK, NY, 10038, US

(21) Appl. No.: 12/146,759

(22) Filed: Jun. 26, 2008

(51) Int. Cl. G06K 7/01; G06K 7/10

(52) U.S. Cl. 235/462.45; 235/472.01

(57) ABSTRACT

Described are devices and systems for adapting an expansion port at a front end of a mobile computing device without impacting the performance of the device. The device includes a housing having a front end, a data capturing arrangement positioned on the front end, the data capturing arrangement collecting data from one or more automatic identification items, and an expansion port positioned on the front end, the expansion port receiving an expansion module increasing the functionality of the device. The system includes a mobile computing device including a housing having a front end, a data capturing arrangement positioned on the front end, the data capturing arrangement collecting data from one or more automatic identification items, and an expansion port positioned on the front end, and an expansion module increasing the functionality of the device, the expansion module receivable by the expansion port of the mobile computing device.

### FIELD OF INVENTION

The present invention generally relates to systems and methods for adapting an expansion port at a front end of a mobile computing device without impacting the performance of the device.

### BACKGROUND

Mobile computing devices, or mobile units (“MUs”), such as RFID readers, barcode scanners, image-based scanners, radio transceivers, video cameras, etc., are used in a multitude of situations for both personal and business purposes. As the benefits of utilizing MUs expand rapidly across more industries, the features of these products expand at a corresponding pace. Accordingly, a demand exists for MUs to perform more complicated tasks in a quick, efficient and reliable manner.

Business enterprises as well as individuals rely on mobile computing devices, such as MUs, in a variety of situations ranging from basic everyday tasks, such as telecommunications, to highly specialized procedures, such as inventory gathering. As the benefits of utilizing MUs continue to be realized across increasingly diverse industries, the features and capabilities of these products are expanding at a correspondingly rapid pace. In many industries, MUs have gone from fashionable accessories to essential business components used by all levels of personnel.

As MUs are constantly improved to have a smaller size and a lighter weight, users constantly desire additional functionalities to be built into these mobile devices. In some instances, these additional functionalities require the user to adapt and expand on the capabilities of the MU. However, as the MUs become smaller, there is little to no room to add additional user interfaces for these functionalities.

### SUMMARY OF THE INVENTION

The present invention relates to devices and systems for adapting an expansion port at a front end of a mobile computing device without impacting the performance of the device. The device includes a housing having a front end, a data capturing arrangement positioned on the front end, the data capturing arrangement collecting data from one or more automatic identification items, and an expansion port positioned on the front end, the expansion port receiving an expansion module increasing the functionality of the device. The system includes a mobile computing device including a housing having a front end, a data capturing arrangement positioned on the front end, the data capturing arrangement collecting data from one or more automatic identification items, and an expansion port positioned on the front end, and an expansion module increasing the functionality of the device, the expansion module receivable by the expansion port of the mobile computing device.

### BRIEF DESCRIPTION OF THE DRAWINGS

FIG. 1a shows an exemplary system comprising an expansion module mounted to an expansion port of general-purpose handheld mobile computing device, such as the MU, according to the exemplary embodiments of the present invention.

FIGS. 1b and 1c show exemplary embodiments of an expansion port of general-purpose handheld mobile computing device, such as the MU, according to the exemplary embodiments of the present invention.

FIG. 2 shows is a block diagram of a system for adapting an expansion arrangement, such as the expansion port, onto a general-purpose handheld mobile computing device, such as the MU, according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for expanding the functionalities of a general-purpose handheld mobile computing device, or mobile unit (“MU”), through the use of accessories such as expansion modules. Specifically, the exemplary embodiments of the present invention are related to a system and method for adapting an expansion arrangement, such as an expansion port, onto the MU.

An exemplary embodiment of the MU may include, but is not limited to, a laser based scanner, an image-based scanner, a radio frequency identification (“RFID”) reader, an ultrahigh frequency (“UHF”) RFID reader, a personal digital assistant (“PDA”), a mobile telephone, a location awareness device (i.e., a real-time location system (“RTLS”)), a global positioning system (“GPS”) device, a portable gaming console, a laptop, etc. Various embodiments of the present invention will be described with reference to an exemplary MU. However, those skilled in the art will understand that the present invention may be implemented with any electrical and/or mechanical hand-operated device that can be attached to a modular accessory.

Conventional MUs, such as scanning devices, do not have an expansion port to accommodate accessories on the scanning end of the device. Specifically, there has not been an opportunity to improve on the feature set of scanning devices in a modular manner due to the fact that the design form and ergonomics of the scanning devices have not lent themselves to this level of integration. Accordingly, scanner accessories are typically limited only to power cable or support stands. Furthermore, existing accessories have been limited to cables interfaces located at the base (e.g., the foot) of the scanning device. Thus, a user's ability to add features (e.g., modules, accessories, etc.) to their MUs, without impacting the performance of the MU, is limited.

However, the exemplary systems and method of the present invention address this issue. As will be described in greater detail below, the exemplary expansion port of the MU is disposed at a face portion, or a front end, of a housing of the MU. For instance, in the example in which the MU is a scanning device, the expansion port may be located at a scan exit window on the front end of the device's housing. Accordingly, electrical and mechanical interfaces may be included within the expansion port of the MU, thereby allowing for modules to be integrated (e.g., plugged, connected, coupled, etc.) into the front end of the MU and add additional functions to the overall performance of the MU.

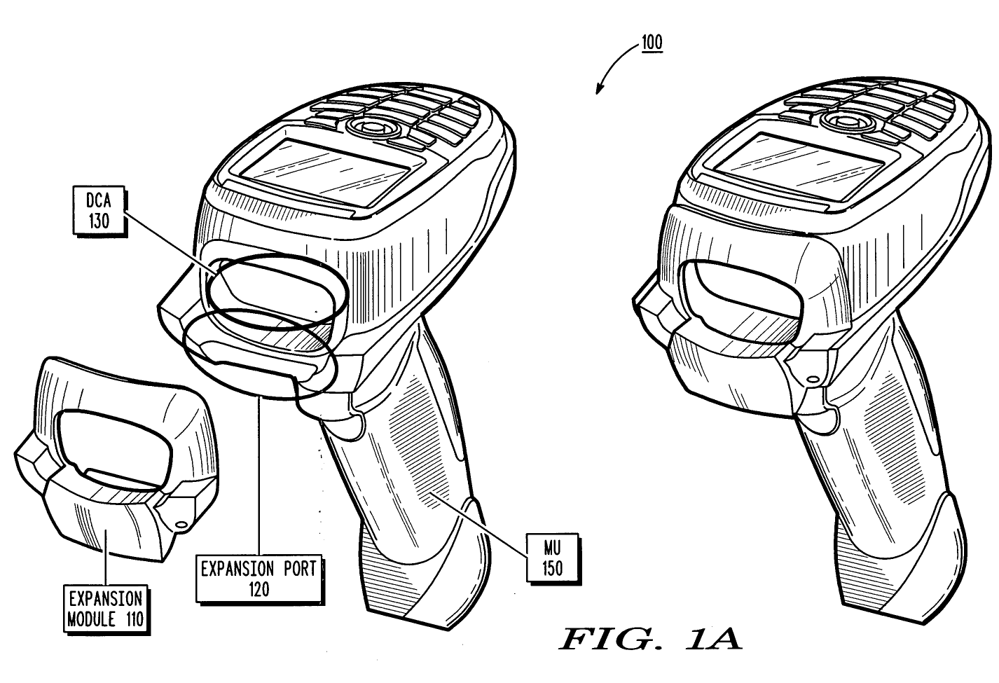

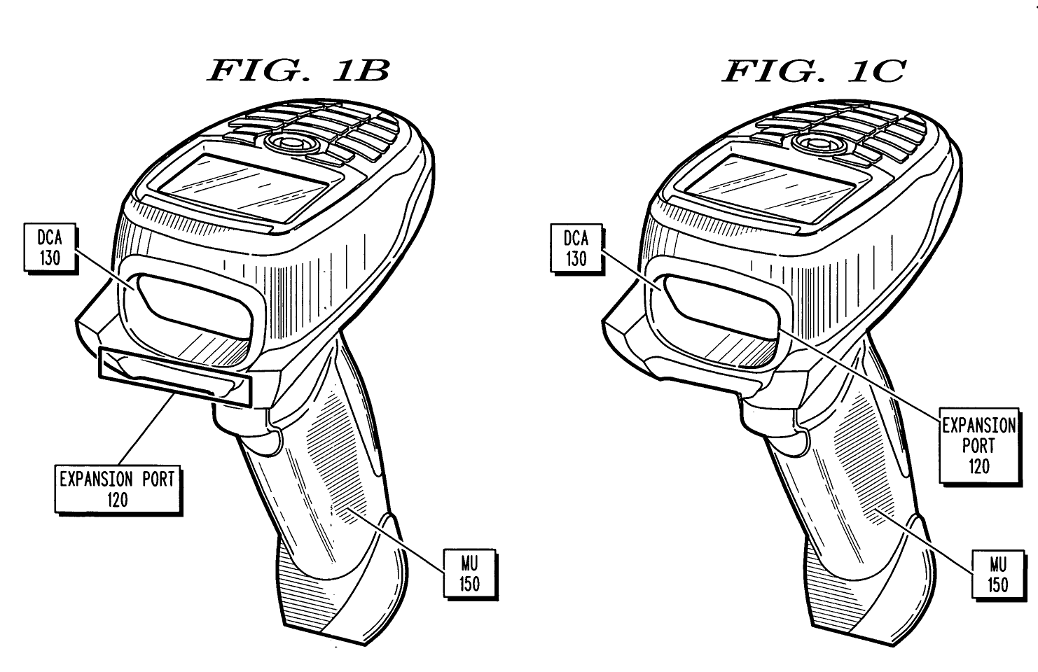

FIG. 1a shows an exemplary system 100 comprising an expansion module 110 mounted to an expansion port 120 of an MU 150 according to the exemplary embodiments of the present invention. As described above, the MU 150 may be a general-purpose handheld computing device, such as a barcode scanner.

According to one embodiment of the present invention, the exemplary MU 150 may be used by a package delivery service. For example, the MU 150 may be capable of scanning a barcode of the package and or delivery receipt. Accordingly, a user may wish to also track the package via an RFID tag on the package. Therefore, the exemplary expansion module 110 may provide an RFID communication function to the MU 150. In another example, the MU 150 may gather product inventory information within a warehouse setting. For example, the MU 150 may retrieve and display a list of items inventoried by the user. Accordingly, the user may wish to also track and/or display the location of an RFID tag placed on an item, another MU, another user, etc. Alternatively or additionally, the user may wish to transmit the collected information to an access point within wireless local area network (“WLAN”). Therefore, the exemplary expansion module 110 may provide an RFID communication function and/or a WLAN communication function to the MU 150. Thus, various expansion modules 110 placed within the expansion port 120 of the MU 150 may increase the functionality of the MU 150. Accordingly, the expansion module may include one or more antennas for wirelessly communicating with RFID tags, GPS tags, network components (routers, access points, etc.), as well as other MUs.

As described above, the exemplary embodiments of the systems and method may adapt the expansion port 120 at the front end of the MU housing without impacting the performance of the MU 150. It should be noted that the front end of the MU may include an arrangement for receiving and/or transmitting data. For example, the MU may include a data capturing arrangement (“DCA”) 130 for collecting data from items such automatic identification items (e.g., barcode, RFID tags, a picture received from an imager, etc.). Accordingly, the front end of the MU 150 may be described as, but is not limited to, a data receiving end, a barcode scanning end (e.g., a scan exit window), an image-based scanning end (e.g., an imager), an RF communication end (e.g., an antenna), etc. The DCA 130 may include one or more modules for electronically capturing data (e.g., receiving and/or transmitting data). For example, these modules may include, but are not limited to automatic identification devices. Thus, an exemplary DCA 130 may utilize one or more RF antennas, barcode lasers, imaging sensors, imaging devices, etc.

While the exemplary expansion module 110 may be described as an RFID reader attached to the expansion port 120 on the MU 150, the systems and methods of the present invention may include alternative or additional modules. For example, the exemplary expansion module 110 may be one of an electronic article surveillance (“EAS”) reader, a local area network (“LAN”) communication interface, a wide area network (“WAN”) communication interface, a personal area network (“PAN”) communication interface, a modem, a magnetic stripe reader, a smart card reader, a voice recognition interface, a biometric reader, etc. Thus, any feature that may be appropriate for modularization may be implemented within the expansion port at the front end of the MU.

According to the exemplary embodiments of the MU 150, locating the expansion port 120 in the front end may enable many possible modular accessories to be designed, implemented, and used by a user of the MU 150. For example, a modular RFID accessory may be added to the MU 150 by the user, thereby easily adding RFID reader functionality to the MU 150. Furthermore, the user may also remove the modular RFID accessory when this functionality is not needed. In other words, the user may easily switch an operation of the MU 150 from a back-of-store application (e.g., an inventory application) to a front-of-store application (e.g., a point of sale application). Thus, the exemplary systems and methods may add considerable value to existing products by eliminating the need for a second device, such as payment only device.

In the attached configuration, as shown in FIG. 1a, the expansion port 120 of the MU 150 may be mated to a receiving arrangement of the expansion module 110 in order to securely maintain both a mechanical and an electrical connection between the two devices. Although the exemplary embodiments described herein utilize an externally coupled accessory device, other embodiments may include accessory devices that are internally coupled to the MU 150. For example, in one embodiment, the MU 150 may include a compartment for receiving the expansion module 110, which may be placed therewithin by sliding, snapping, rotating, etc. Thus, the expansion module 110 may be partially or fully received within the housing of the MU 150.

FIGS. 1b and 1c show exemplary embodiments of an expansion port 120 of general-purpose handheld mobile computing device, such as the MU 150, according to the exemplary embodiments of the present invention. As described above, the exemplary expansion port 120 may be located at a front end of the MU 150, such as near a scan exit window on the device's housing. Therefore, the expansion port 120 may reside in proximity to the optical features of the MU 150. Specifically, as illustrated in FIG. 1b, the expansion port 120 may reside below the DCA 130. However, the expansion port 150 may not be limited to this region. Alternatively, as illustrated in FIG. 1c, the expansion port 120 may extend around the exit window of the DCA 130. By wrapping the expansion module 110 around the optical aperture, the available volume for additional features may be maximized. Thus, integrating the expansion module 110 in this region allows all of the features of the MU 150 to coexist in the same volume. It should be noted that the placement of the expansion port 150 in FIGS. 1b and 1c are merely examples of locations, as the expansion port 150 may be located anywhere on the front end of the MU 150 (e.g., near the scan exit window).

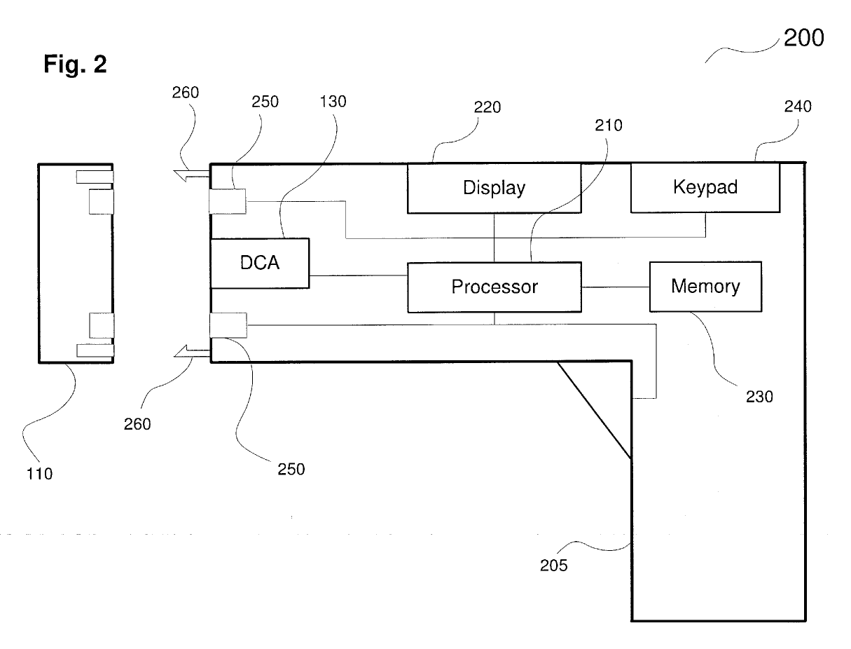

FIG. 2 is a block diagram 200 of the system 100 for adapting an expansion arrangement, such as the expansion port 120, onto a general-purpose handheld mobile computing device, such as the MU 150. As shown in FIG. 2, the exemplary MU 150 may include a processor 210, a display screen 220, a memory 230, the DCA 130 (e.g., a barcode scanner, a RFID reader, magnetic stripe reader, smart card reader, etc.), a keypad 240, an electrical interface 250, and a mechanical interface 260. Furthermore, the MU 150 may include a housing 205 for enclosing and protecting various components of the MU 150. Accordingly, the MU 150 may incorporate any number of automatic identification data capturing methods.

The processor 210 may include one or more electrical components for executing a function of the exemplary MU 150. For example, if the DCA 130 of the MU 150 includes a barcode scanner/reader, then processor 210 may include an arrangement for reading data electronically captured from reading a barcode. Furthermore, if the DCA 130 of the MU 150 further includes an RFID reader, then processor 210 may also, or alternatively, include an arrangement for receiving data from RF tags. The processor 210 may also include software components for controlling operation of the various electrical/hardware components of the MU 150.

In addition, the processor 210 may regulate the operation of the MU 150 by facilitating communications between the various components of the MU 150, as well as communication between the MU 150 and an attached mobile computing device. For example, the processor 210 may include one or more microprocessors, an embedded controller, an application-specific integrated circuit, a programmable logic array, etc. The processor 210 may perform data processing, execute instructions and direct a flow of data between devices coupled to the MU 150 (e.g., the display screen 220, the DCA 130, the keypad 240, etc.). As will be explained below, when the expansion module 110 is attached to the expansion port 120, the processor 210 may communicate with the module 110 via the electrical interface 250, and/or may communicate this data to a remote device via the wireless communication interface (e.g., using a Bluetooth protocol, an IEEE 802.1x protocol, a WAN Protocol, etc.).

The display screen 220 may display viewable data images generated by the processor 210. According to one example, the display screen 220 may include a touch screen. Specifically, a display screen 220 implemented as a touch screen serves as an input device that may supplement the keypad 240 and/or a pointing device (e.g., a mouse). Therefore, the touch screen may allow the user to interact with a graphical user interface (“GUI”) on the display screen 220 via a stylus or the user's finger.

The memory 230 may be any storage medium capable of being read from and/or written to by the processor 210. The memory 230 may include any combination of volatile and/or nonvolatile memory (e.g., RAM, ROM, EPROM, Flash, etc.). In addition, the memory 230 may also include one or more storage disks such as a hard drive. Accordingly, the memory 230 may be a temporary memory in which data (e.g., captured data, verification data, etc.) may be temporarily stored until it is transferred to a different storage location (e.g., the expansion module 110 via the electrical interface 250). In another embodiment, the memory 230 may be a permanent memory comprising an updateable database.

According to the exemplary embodiments of the present invention, the mechanical interface 260 allows the expansion module 110 to be physically attached to the front end of the MU 150. Specifically, the mechanical interface 260 may allow for the expansion module 110 to detachably couple to expansion port 120 the MU 150. For example, the mechanical interface 260 may comprise one or more slots selectively coupled to one or more corresponding interlocking tabs located on a housing of the MU 150. The mechanical interface 260 may also be located on the front end of the MU 150, and slots may be shaped to complement the tabs, allowing the MU 150 to be snapped into place. Those of skill in the art will understand that the MU 150 may utilize any mechanism for detachably receiving the expansion module 110 at the expansion port 120 including, but not limited to, screws, hooks, clasps, adhesives, Velcro®, magnets, etc.

Once the expansion module 110 is attached to the MU 150, the electrical interface 250 may create an electrical connection in which data may be exchanged between the components. Specifically, the electrical interface 250 may include one or more electrical contacts for attaching the expansion module 110 to an MU 150. For example, the contacts may comprise one or more sets of input/output (I/O) pins, such as a Universal Serial Bus (USB) port, a serial port, etc. In addition, the electrical interface 250 may provide power and/or data transfer capabilities to a conventional (e.g., legacy) accessory device. However, it should be noted that the expansion module 110 may be a self-powered device and/or may receive power wirelessly (e.g., via induction) from the MU 150 or a further source.

As described above, the implementation of the expansion port 120 allows for future growth on the MU 150. Specifically, the system 100 may add feature modularity with the expansion port 120 on the front end of the MU 150. Therefore, a user may decide, after a product (e.g., the MU 150) has been purchased, that additional functionality may be required. With the expansion port 120 built into the front end of the product, the user may simply purchase an add-on expansion module 110, thereby adding application flexibility to the product, as well as extending the lifespan of the product.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A device, comprising:
a housing having a front end;
a data capturing arrangement positioned on the front end, the data capturing arrangement collecting data from one or more automatic identification items; and
an expansion port positioned on the front end, the expansion port receiving an expansion module increasing the functionality of the device.

2. The device according to claim 1, further comprising:
a connection interface positioned on the front end of the housing, the connection interface including at least one of an electrical interface and a mechanical interface.

3. The device according to claim 1, further comprising:
a processor regulating an operation of the device by facilitating communications between the expansion port and the expansion module, the processor processing the data collected from the data capturing arrangement.

4. The device according to claim 1, wherein the data capturing arrangement includes one of a barcode reader, an imaging sensor, a radio frequency identification antenna, a location awareness system, and a global positioning system.

5. The device according to claim 1, wherein the data collected from the data capturing arrangement is received from one of a barcode, a radio frequency identification tag, a global positioning tag, and an image from an image-based scanner.

6. The device according to claim 1, wherein the expansion module includes one or more antennas for wirelessly communicating with at least one or more RFID tags, GPS tags, routers, access points, and further devices.

7. The device according to claim 1, wherein the expansion module includes at least one of a radio frequency identification (“RFID”) reader, an ultrahigh frequency (“UHF”) RFID reader, an electronic article surveillance (“EAS”) reader, local area network (“LAN”) communication interface, wide area network (“WAN”) communication interface, personal area network (“PAN”) communication interface, a modem, a magnetic stripe reader, a smart card reader, a voice recognition interface, and a biometric reader.

8. A system, comprising:
a mobile computing device including a housing having a front end, a data capturing arrangement positioned on the front end, the data capturing arrangement collecting data from one or more automatic identification items, and an expansion port positioned on the front end; and
an expansion module increasing the functionality of the device, the expansion module receivable by the expansion port of the mobile computing device.

9. The system according to claim 8, wherein the mobile computing device further includes a connection interface positioned on the front end of the housing, the connection interface including at least one of an electrical interface and a mechanical interface.

10. The system according to claim 8, wherein the mobile computing device further includes a processor regulating an operation of the device by facilitating communications between the expansion port and the expansion module, the processor processing the data collected from the data capturing arrangement.

11. The system according to claim 8, wherein the data capturing arrangement includes one of a barcode reader, an imaging sensor, a radio frequency identification antenna, a location awareness system, and a global positioning system.

12. The system according to claim 8, wherein the data collected from the data capturing arrangement is received from one of a barcode, a radio frequency identification tag, a global positioning tag, and an image from an image-based scanner.

13. The system according to claim 8, wherein the expansion module includes one or more antennas for wirelessly communicating with at least one or more RFID tags, GPS tags, routers, access points, and further devices.

14. The system according to claim 8, wherein the expansion module includes at least one of a radio frequency identification (“RFID”) reader, an ultrahigh frequency (“UHF”) RFID reader, an electronic article surveillance (“EAS”) reader, local area network (“LAN”) communication interface, wide area network (“WAN”) communication interface, personal area network (“PAN”) communication interface, a modem, a magnetic stripe reader, a smart card reader, a voice recognition interface, and a biometric reader.

15. A device, comprising:
a housing means having a front end;
a data capturing means, positioned on the front end, for collecting data from one or more automatic identification items; and
an expansion port means, positioned on the front end, for receiving an expansion module increasing the functionality of the device.

16. The device according to claim 15, further comprising:
a connection interface means, positioned on the front end of the housing, for one of electrically and mechanically coupling the expansion module to the expansion port means.

17. The device according to claim 15, further comprising:
a processing means for regulating an operation of the device by facilitating communications between the expansion port means and the expansion module, the processing means processing the data collected from the data capturing arrangement.

18. The device according to claim 15, wherein the data capturing means includes one of a barcode reader, an imaging sensor, a radio frequency identification antenna, a location awareness system, and a global positioning system.

19. The device according to claim 15, wherein the expansion module includes one or more antennas for wirelessly communicating with at least one or more RFID tags, GPS tags, routers, access points, and further devices.

20. The device according to claim 16, wherein the expansion module includes at least one of a radio frequency identification (“RFID”) reader, an ultrahigh frequency (“UHF”) RFID reader, an electronic article surveillance (“EAS”) reader, local area network (“LAN”) communication interface, wide area network (“WAN”) communication interface, personal area network (“PAN”) communication interface, a modem, a magnetic stripe reader, a smart card reader, a voice recognition interface, and a biometric reader.
